(19) United States
(12) Patent Application Publication
(10) Pub. No.: US 2012/0200066 A1
(43) Pub. Date: Aug. 9, 2012

(54) SELF-LATCHING PIN HITCH

(76) Inventor: CHARLES ROCHELLE, Ranger, TX (US)

(21) Appl. No.: 13/023,418

(22) Filed: Feb. 8, 2011

(51) Int. Cl. B60D 1/36

(52) U.S. Cl. 280/477

(57) ABSTRACT

A self-latching pin assembly that allows for the insertion of a hitch ball assembly comprising: a square tubing, where the square tubing extends horizontally from a vehicle chassis; a horizontally retracting bumper within the square tubing, where the bumper allows for the insertion of a hitch assembly; a vertical tube, where the vertical tube enables the retraction and extension of a round bar; flat bars, where the flat bars extend horizontally from the square tubing; and holes in the flat bars, where the holes are aligned with the round bar and allow for the insertion of the round bar into the hitch ball assembly. In one particular embodiment, the vertical tube may include a cap and a vertical compression spring, where the vertical compression spring enables the vertical retraction and extension of the round bar to secure the hitch ball assembly.

### BACKGROUND OF THE INVENTION

1. Field of Invention

The present invention relates to a self-latching pin for a hitch so that the pin is readily available to position a hitch onto a bumper for towing purposes.

2. Description of Related Art

A tow hitch provides a means to attach a trailer to the bumper or chassis of a vehicle for towing purposes. The tow hitch is usually in the form of a tow bar that allows for the swiveling or articulation of the trailer or a tow pin and jaw with a trailer loop often used for a large or agricultural vehicle where the slacking in the pivot pin allows the same movements. The tow hitch usually includes a rigid framework with a coupling structure such as a hitch bar affixed to the structure. The hitch may be permanently secured to the rear of the towing vehicle and a trailer vehicle is attached to the hitch. The hitch ball configuration is usually attached by use of a hitch assembly that locks the hitch ball into a rigid position to receive the trailer receptacle coupling structure. Many times the pin that is used to attach or secure the hitch ball assembly is not permanently in place and therefore must be retrieved to insert through the coupling structure to secure the hitch ball into place. Many times this attaching pin is lost or misplaced therefore it is difficult to secure the hitch ball into place onto the towing vehicle. Consequently it would be advantageous to have a pin that is secured in a permanent manner and easily locked into place for insertment of a hitch ball onto a towing vehicle.

### SUMMARY OF THE INVENTION

The present invention relates to a self-latching pin assembly that allows for the insertion of a hitch ball assembly comprising: a square tubing, where the square tubing extends horizontally from a vehicle chassis; a horizontally retracting bumper within the square tubing, where the bumper allows for the insertion of a hitch assembly; a vertical tube, where the vertical tube enables the retraction and extension of a round bar; flat bars, where the flat bars extend horizontally from the square tubing; and holes in the flat bars, where the holes are aligned with the round bar and allow for the insertion of the round bar into the hitch ball assembly. In one particular embodiment, the vertical tube may include a cap and a vertical compression spring, where the vertical compression spring enables the vertical retraction and extension of the round bar to secure the hitch ball assembly. A roll pin may be provided for insertion in the vertical tube and locks the tube into an upright position. A second round bar extends from a surface of the bumper and a horizontal compression spring extends over the second round bar. Further, a second roll pin engaging in the second round bar and securing the bumper and compression spring assembly in the square tubing.

### BRIEF DESCRIPTION OF DRAWINGS

FIG. 1 depicts a self-latching pin assembly in accordance with the present invention.

### DETAILED DESCRIPTION

The present invention relates to a self-latching pin assembly that allows for the insertion of a hitch ball assembly where the pin is self-latching and attached to the coupling assembly of a vehicle. In accordance with the present invention, the self-latching pin includes a means to align the pin with the attachment holes and hitch assembly. A receiver hitch is placed into an opening by pushing against a bumper/plunger and when the receiving hitch hole is aligned the pin may be guided through the openings into a locked position.

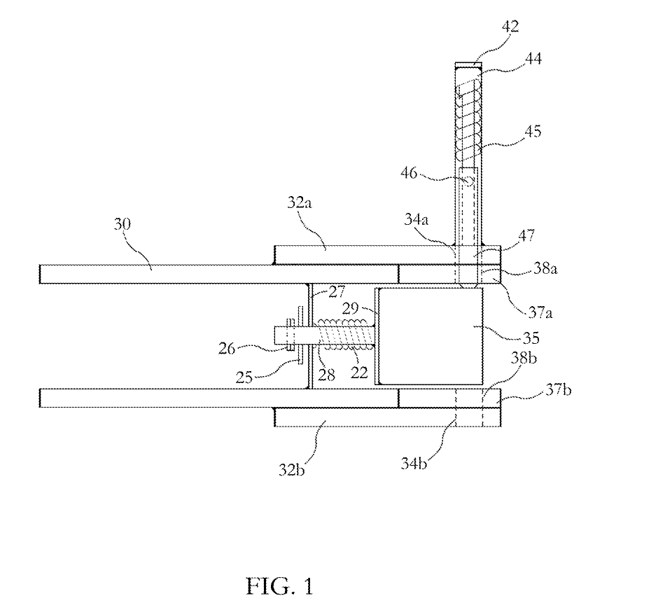

FIG. 1 depicts a self-latching pin assembly in accordance with the present invention. As shown in FIG. 1, a Vertical Tube 44 provides the principal body of the rolling pin that adjoins the hitch assembly into place for towing purposes. The Vertical Tube 44 includes the Cap 42 and within the Vertical Tube 44 is a compression Spring 45. The compression Spring 45 compresses vertically and allows for the Vertical Tube 44 to be locked into place when the hitch assembly is placed within the square tubing assembly below the roll pin. A Roll Pin 46 is provided within the Vertical Tube 44 that locks the tube into an upright position and therefore may be removed to allow the compression of the Vertical Tube 44 into place with the hitch assembly. A Round Bar 47 extends downwardly from the Vertical Tube 44, where the Round Bar 47 goes through Hole 34a and Hole 38a and is depressed into the hitch assembly once the hitch assembly is inserted into the Square Tubing 30. The first Hole 34a is part of a top flat Bar 32a and the second Hole 38a goes through an abutting flat Bar 37a. The holes and Bar 47 are aligned so the user only needs to insert the hitch assembly into the Tubing 30. Some of additional alignment bars are shown at the bottom of the Square Tubing 30 such as Flat Bar 32b, which includes a Hole 34b and Flat Bar 37b includes a Hole 38b. The Round Bar 47 extends downwardly into these Holes 38b and 34b once the pin is depressed through the hitch assembly.

Further components of the self-latching pin assembly are provided in the Square Tubing 30. A Bumper 35 within the Square Tubing 30 is depressed horizontally toward a Flat Bar 27 when as the hitch assembly is inserted within the Square Tubing 30. This resilient bumper 35 includes a Compression Spring 22 that slips over a Round Bar 28 that extends horizontally from a Surface 29 of Bumper 35. Bar 28 extends through the Flat Bar 27 and is locked in place with the Roll Pin 26. A Washer 25 is provided between the Roll Pin 26 and Flat Bar 27. As the hitch is placed within the Square Tubing 30, the Bumper 35 depresses toward the Flat Bar 27 and thus allows for the entry of the Round Bar 47 into the Square Tubing 30 and through the hitch assembly.

The self-latching hitch pin according to the present invention enables the user to lift the pin upward prompting the small tubing to slide forward underneath and thus release the pin. As the user positions the hitch assembly into the opening by pushing against the Bumper 35 and allowing the hole of the hitch assembly to align with the holes of the hitch pin and then the Round Bar 47 may be pushed through the openings into a locked position. When not in use, the Round Bar 47 remains in a locked position above the Square Tubing 30. The instant invention has been shown and described in what it considers to be the most practical and preferred embodiments. It is recognized, however, that departures may be made there from within the scope of the invention and that obvious modifications will occur to a person skilled in the art.

What is claimed is:

1. A self-latching pin assembly that allows for the insertion of a hitch ball assembly comprising:
a. a square tubing, where the square tubing extends horizontally from a vehicle chassis;
b. a horizontally retracting bumper within the square tubing, where the bumper allows for the insertion of a hitch assembly;
c. a vertical tube, where the vertical tube enables the retraction and extension of a round bar;
d. flat bars, where the flat bars extend horizontally from the square tubing; and
e. holes in the flat bars, where the holes are aligned with the round bar and allow for the insertion of the round bar into the hitch ball assembly.

2. The self-latching pin assembly according claim 1, where the vertical tube includes a cap.

3. The self-latching pin assembly according claim 1, where the vertical tube includes a vertical compression spring, where the vertical compression spring enables the vertical retraction and extension of the round bar to secure the hitch ball assembly.

4. The self-latching pin assembly according claim 3, where a roll pin is provided for insertion in the vertical tube and locks the tube into an upright position.

5. The self-latching pin assembly according claim 1, where a second round bar extends from a surface of the bumper and a horizontal compression spring extending over the second round bar.

6. The self-latching pin assembly according claim 5, a second roll pin engaging in the second round bar and securing the bumper and compression spring assembly in the square tubing.
